(19) United States
(12) Patent Application Publication
(10) Pub. No.: US 2018/0297541 A1
(43) Pub. Date: Oct. 18, 2018

(54) VEHICULAR WIRING MEMBER

(71) Applicant: YAZAKI CORPORATION, Tokyo (JP)

(72) Inventors: Masahiro Ito, Shizuoka (JP); Yuta Kawamura, Shizuoka (JP); Sadaharu Okuda, Shizuoka (JP)

(21) Appl. No.: 15/920,078

(22) Filed: Mar. 13, 2018

(30) Foreign Application Priority Data
Apr. 12, 2017 (JP) 2017-079030

(51) Int. Cl. B60R 16/02; H01R 4/30; H01R 4/58; H02G 3/04; H02G 3/08

(52) U.S. Cl. CPC B60R 16/0215; H01R 4/308; H01R 4/58; H01B 7/0045; H02G 3/0406; H02G 3/083; H02G 3/0437

(57) ABSTRACT

A vehicular wiring member installed in a vehicle includes a conductive path that includes a conductive member having an elongated shape. The conductive path includes an impact absorption portion which has a structure to easily absorb an impact added to the conductive member compared to a portion of the conductive path other than the impact absorption portion.

### CROSS REFERENCE TO RELATED APPLICATIONS

This application is based on Japanese Patent Application (No. 2017-079030) filed on Apr. 12, 2017, the contents of which are incorporated herein by reference.

### BACKGROUND OF THE INVENTION

### 1. Field of the Invention

The present invention relates to a vehicular wiring member which is wired in a vehicle and includes a long conductive member.

### 2. Description of the Related Art

In the related art, there is known a long (main-line) wiring member which is wired in a vehicle and is capable of transferring power. As an example of the main-line wiring member, there is a long main-line wiring member which is wired along a front and rear direction of the vehicle in order to supply power between a front side and a rear side of the vehicle and to make a ground state (for example, see JP-A-2016-107830). Such a main-line wiring member is called a backbone, and the power supplied to electric components disposed in each part in the vehicle is distributed from the backbone in a direct manner or through a branch wiring member.

In such a main-line wiring member (backbone), there is a need to supply a large amount of current, and thus the cross-sectional area of the wiring member is remarkably large compared to a cross-sectional area of a typical electric wire (wire harness) which is connected to the auxiliary devices. Therefore, the rigidity of the main-line wiring member becomes significantly high, and the entire main-line wiring member has a structure nearly as one rigid body.

Accordingly, for example, when an impact is added to one end of the main-line wiring member toward the other end of the main-line wiring member at the time of collision of the vehicle, the impact can be transferred to the other end side of the main-line wiring member through the entire main-line wiring member having a structure nearly as one rigid body without any attenuation of the impact. As a result, a large force may also be applied to a control device connected to both ends of the main-line wiring member so that a failure easily occurs in the control device, which is problematic. There is a strong request to prevent that the large force causes the main-line wiring member to be broken away.

### SUMMARY OF THE INVENTION

The invention has been made in view of the above-described problems, and an object thereof is to provide a vehicular wiring member which prevents an influence on a connected control device when an impact is added and is hardly broken away itself.

To achieve the above objections, vehicular wiring members of (1) to (5) according to the invention are provided.

(1) There is provided a vehicular wiring member installed in a vehicle, including:

a conductive path that includes a conductive member having an elongated shape,

wherein the conductive path includes an impact absorption portion which has a structure to easily absorb an impact added to the conductive member compared to a portion of the conductive path other than the impact absorption portion.

(2) There is provided the vehicular wiring member according to the configuration [1], wherein the conductive member includes a low rigidity portion which has a rigidity lower than a portion of the conductive member other than the low rigidity portion; and

wherein the low rigidity portion serves as the impact absorption portion.

(3) There is provided the vehicular wiring member according to the configuration [2], wherein the conductive member has a flat plate shape; and

wherein the low rigidity portion is a curved portion which is formed by bending the conductive member a plurality of times in a thickness direction of the conductive member along a longitudinal direction of the conductive member.

(4) There is provided the vehicular wiring member according to the configuration [1], wherein the conductive member is configured by coupling a pair of conductive members to each other in a long rod shape;

wherein each of coupling portions of the pair of conductive members has a through hole;

wherein the coupling portions are overlapped and a bolt passes through the through holes of the pair of conductive members, and the pair of conductive members are fixed by bolt-fastening;

wherein at least one of the through holes extends in the longitudinal direction of the conductive member;

wherein the pair of conductive members has a structure in which an overlapping portion in the longitudinal direction of the coupling portions is changeable within a predetermined range during the bolt-fastening; and

wherein the structure serves as the impact absorption portion.

(5) There is provided the vehicular wiring member according to the configuration [1], wherein both ends of the conductive member are connected to a pair of control devices respectively;

the vehicular wiring member further including:

a pair of first fixing members which are positioned so as to be adjacent to the pair of control devices and between the pair of control devices to fix the conductive member to a vehicle body; and

a second fixing member which is positioned between the pair of first fixing members to fix the conductive member to the vehicle body,

wherein the second fixing member is configured such that fixing of the conductive member to the vehicle body is easily released when receiving an impact compared to the first fixing member; and

wherein the second fixing member serves as the impact absorption portion.

(6) There is provided the vehicular wiring member according to the configuration [5], wherein the second fixing member includes a pair of engaging portions;

wherein the pair of engaging portions are engaged to each other to annularly cover an outer periphery of the conductive member to fix the conductive member to the vehicle body; and

wherein the second fixing member is configured such that engagement of the engaging portions is released when receiving an impact, so as to release the fixing of the conductive member to the vehicle body.

According to the vehicular wiring member of the configuration (1), the impact absorption portion is provided in the conductive member, so that part of the impact can be absorbed by the impact absorption portion when the impact is added to the conductive member. Therefore, a force applied by the impact on the control device connected to the vehicular wiring member is reduced, and the control device is hardly broken down. Further, the vehicular wiring member itself is hardly broken away.

According to the vehicular wiring member of the configuration (2), the low rigidity portion is provided in the conductive member itself, so that part of the impact can be securely absorbed by the low rigidity portion when the impact is added to the conductive member. The low rigidity portion is easily deformed. As a result, since the low rigidity portion is deformed, a dimensional variation generated at the time of assembly between the vehicular wiring member and the control device connected to the vehicular wiring member can be absorbed, so that the assembly performance is improved. The rigidity indicates a characteristic of being hardly deformed when receiving an external force, and a low (high) rigidity indicates that a deformation amount when receiving the external force is large (small).

According to the vehicular wiring member of the configuration (3), the low rigidity portion is formed by bending the conductive member in the thickness direction along the longitudinal direction a plurality of times, so that an absorbing degree of the impact can be increased.

According to the vehicular wiring member of the configuration (4), the vehicular wiring member has a structure in which the overlapping portion in the longitudinal direction between the coupling portions of the pair of conductive members is changeable within a predetermined range during bolt-fastening. Thus, when the impact is added to the conductive member, the coupling portions relatively move in the longitudinal direction, and the overlapping portion is changed, so that part of the impact can be absorbed. In addition, the absorbing degree of the impact can be arbitrarily adjusted by adjusting a fastening load of the bolt. Since a dimensional variation generated at the time of assembly between the vehicular wiring member and the control device connected to the vehicular wiring member is absorbed by adjusting the overlapping portion of the coupling portions, the assembly performance is improved.

According to the vehicular wiring member of the configuration (5), when an impact is added to the conductive member, fixing of the conductive member to the vehicle body by the second fixing member positioned between the pair of first fixing members can be released while maintaining fixing of the conductive member to the vehicle body with the pair of first fixing members positioned to be adjacent to the pair of control devices connected to the both ends of the vehicular wiring member. As a result, the conductive members at the positions of the pair of first fixing members are not allowed to move (be deformed), and thus a large force is not applied on the pair of control devices. The conductive member at the position of the second fixing member is allowed to move (be deformed), and thus part of the impact can be securely absorbed.

According to the vehicular wiring member of the configuration of (6), fixing of the conductive member to the vehicle body by the second fixing member is released when the engagement of the engaging portion is released. Thus, the conductive member at the position of the second fixing member is securely allowed to move (be deformed) when the impact is added to the conductive member, so that part of the impact can be securely absorbed.

According to the invention, it is possible to provide a vehicular wiring member which prevents an influence on the connected control device when an impact is added and is hardly broken away itself.

Hereinbefore, the invention has been described simply. Further, modes (hereinafter, referred to as “embodiments”) for carrying out the invention (to be described below) will be described with reference to the accompanying drawings, and the details of the invention will become apparent.

### BRIEF DESCRIPTION OF THE DRAWINGS

FIG. 1 is a view schematically illustrating an example in a case where a vehicular wiring member according to an embodiment of the invention is mounted in a vehicle;

FIG. 2A is a top view of a vehicular wiring member according to a first embodiment of the invention, FIG. 2B is a side view of the vehicular wiring member, and FIG. 2C is a view corresponding to FIG. 2B in which an impact absorption portion (low rigidity portion) is deformed;

FIGS. 3A to 3C are views corresponding to FIGS. 2A to 2C of a vehicular wiring member according to a modification of the first embodiment of the invention;

FIG. 4A is a top view of a vehicular wiring member according to a second embodiment of the invention, FIG. 4B is a cross-sectional view taken along line A-A of FIG. 4A, and FIG. 4C is a view corresponding to FIG. 4B in which an impact absorption portion is relatively moved;

FIG. 5A is a top view of a vehicular wiring member according to a third embodiment of the invention, and FIG. 5B is a view corresponding to FIG. 5A in which an impact absorption portion (second fixing member) is broken away; and

FIG. 6A is a cross-sectional view taken along line B-B of FIG. 5A of the second fixing member which includes a pair of engaging portions, and FIG. 6B is a view corresponding to FIG. 6A in which the pair of engaging portions are released from engagement.

### DETAILED DESCRIPTION OF THE EXEMPLARY EMBODIMENTS

Specific embodiments of the invention will be described below with reference to the drawings.

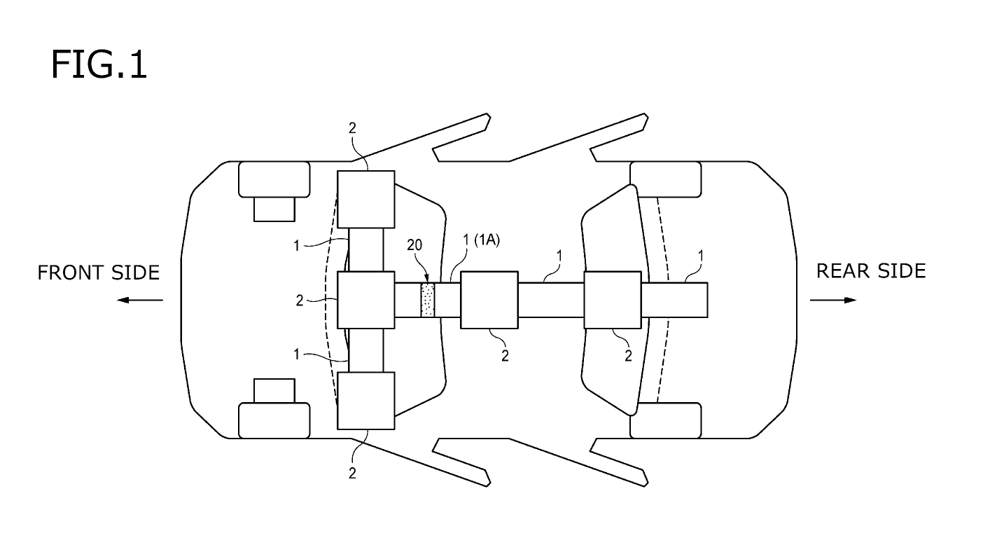

A long wiring member 1 according to an embodiment of the invention is used in the state of being wired in a vehicle as illustrated in FIG. 1. In the example illustrated in FIG. 1, three wiring members 1 are linearly wired through two electrical connection boxes 2 on the upper surface of a floor panel of a vehicle in the front and rear direction, and one wiring member 1 is branched on the dash panel to eight the right or left direction from the electrical connection box 2 positioned on a dash panel attached on the front end of the vehicle. Each of the tip ends of the branched wiring members 1 is connected to the electrical connection box 2. Since a well-known configuration may be employed as the electrical connection box 2, the detailed description thereof will be omitted herein.

Three wiring members 1 wired along the front and rear direction of the vehicle on the upper surface of the floor panel are used as a main-line wiring member which supplies power between a front side and a rear side of the vehicle. Two wiring members 1 branched on the dash panel are used as a branch wiring member to supply power to electric equipment positioned near the dash panel. Three wiring members 1 wired along the front and rear direction of the vehicle are also called a backbone including the electrical connection box 2. The backbone may include a communication circuit (not illustrated) along the wiring member 1 and the branch wiring member on the dash panel. In this embodiment, the wiring member 1 wired along the front and rear direction of the vehicle will be specially called a backbone.

There is a need to supply a large amount of current to such a main-line wiring member (backbone). Therefore, a cross-sectional area of the main-line wiring member is remarkably large compared to that of a typical electric wire (wire harness). Therefore, a rigidity of the main-line wiring member is significantly high, and the entire main-line wiring member has a structure approximate to one rigid body. Accordingly, especially three wiring members 1 wired along the front and rear direction of the vehicle among five wiring members 1 illustrated in FIG. 1 have a large cross-sectional area, and the entire wiring members 1 each have a structure approximate to one rigid body.

Among three wiring members 1 wired along the front and rear direction of the vehicle, the wiring member 1 positioned on the most front side is positioned on the floor panel near the boundary between the floor panel and the dash panel. In the example illustrated in FIG. 1, the wiring member 1 (hereinafter, referred to as “wiring member 1A”) is provided with an impact absorption portion 20 which has a structure to easily absorb an impact compared to other components of the wiring member 1A. Hereinafter, embodiments of the wiring member 1A provided with the impact absorption portion 20 will be described sequentially.

### First Embodiment

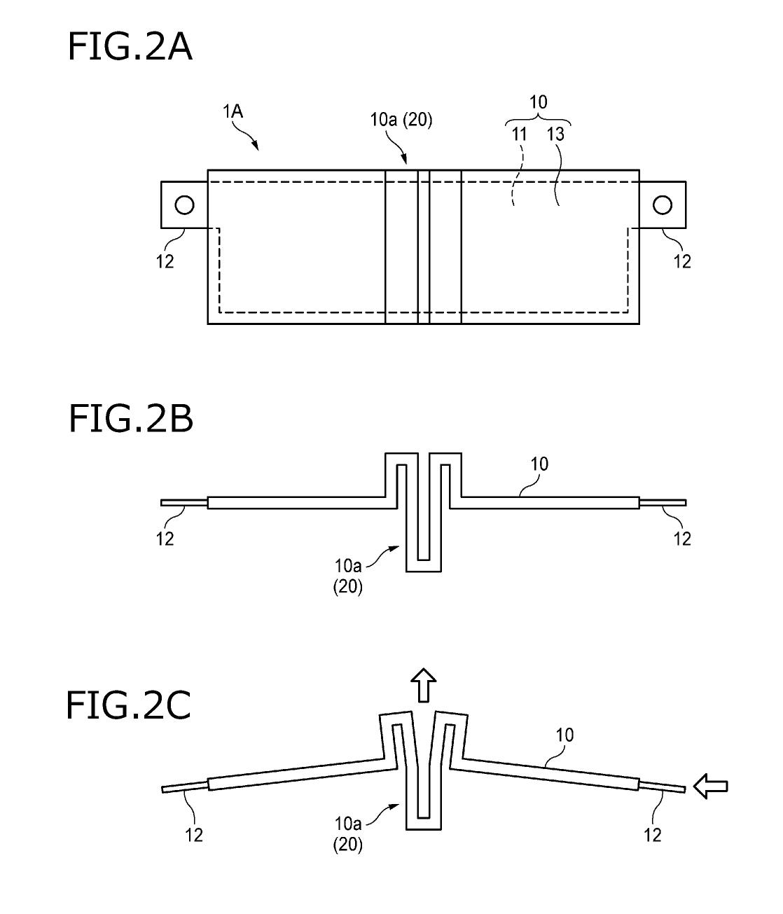

First, a long wiring member 1A according to a first embodiment of the invention will be described with reference to FIGS. 2A to 2C. As illustrated in FIGS. 2A to 2C, the wiring member 1A includes one conductive path 10. The conductive path 10 includes a flat plate conductive member 11 made of metal extending in a longitudinal direction (a right and left direction to the sheet of FIGS. 2A to 2C). A pair of connection portions 12 are integrally formed on both ends in the longitudinal direction in the conductive member 11. The pair of connection portions 12 are portions which are used to be electrically connected to the other conductor (specifically, a conductor portion of the electrical connection box 2 illustrated in FIG. 1). The flat plate conductive member 11 including the pair of connection portions 12 can be formed by punching a sheet of metal plate which has a flat plate shape.

The conductive path 10 includes an insulator (insulative coating/insulative sheath) 13 which covers the whole outer peripheral of the conductive member 11 over the entire region in the longitudinal direction except the pair of connection portions 12. The insulator 13 can be provided by extrusion molding and lamination molding for example.

As illustrated in FIGS. 2A and 2B, the conductive path 10 of the wiring member 1A is provided with a low rigidity portion 10a which has a low rigidity compared to the other portions of the conductive path 10 (conductive member 11). The low rigidity portion 10a is a portion serving as the impact absorption portion 20.

In the example illustrated in FIGS. 2A and 2B, the low rigidity portion 10a is formed such that the conductive member 11 is bent a plurality of times in a thickness direction along the longitudinal direction of the conductive member 11. The low rigidity portion 10a is formed by pressing the conductive member 11 for example. The insulator 13 is preferably provided after the low rigidity portion 10a is formed.

The low rigidity portion 10a has the lowest rigidity in the conductive path 10 (conductive member 11), and thus is deformed most easily. Therefore, as illustrated in FIG. 2C, for example, when an impact is added to one end of the wiring member 1A toward the other end of the wiring member 1A (see a white thick arrow in the drawing), the low rigidity portion 10a is actively deformed (see a thin arrow in the drawing), so that part of the impact is absorbed by the low rigidity portion 10a. Therefore, a force which is caused by the impact and acts on the electrical connection box 2 (see FIG. 1) connected to the wiring member 1A is reduced, and the electrical connection box 2 is hardly broken. Further, the wiring member 1A itself is hardly broken away.

In FIG. 2C, the description has been given about a case where the impact is added along the longitudinal direction of the wiring member 1A. However, even in a case where the impact is added in a width direction (an upward and downward direction to the sheet in FIG. 2A) perpendicular to the longitudinal direction of the wiring member 1A, the low rigidity portion 10a is actively deformed, so that part of the impact can be securely absorbed by the low rigidity portion 10a.

Further, with the deformation of the low rigidity portion 10a which is easily deformed, a dimensional variation generated at the time of assembly between the wiring member 1A and the electrical connection box 2 can be absorbed, so that the assembly performance is improved.

### Modification of First Embodiment

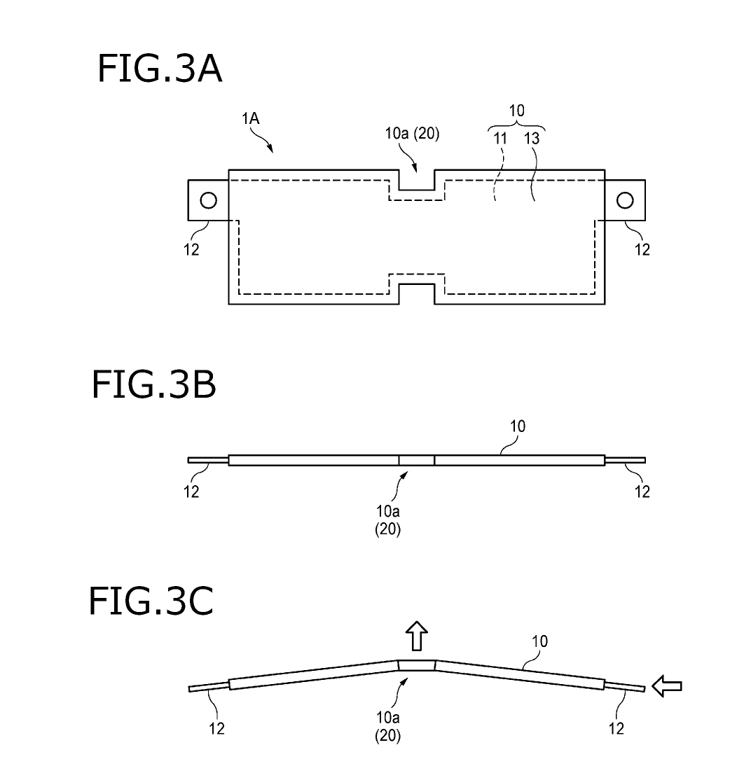

FIGS. 3A to 3C illustrate a long wiring member 1A according to a modification of the first embodiment of the invention. As illustrated in FIGS. 3A and 3B, in the wiring member 1A, the low rigidity portion 10a (impact absorption portion 20) is formed as a small-dimensional portion compared to the other portions in the width direction of the conductive member 11 (conductive path 10).

Even in the wiring member 1A, as illustrated in FIG. 3C, for example, when an impact is added to one end of the wiring member 1A toward the other end of the wiring member 1A (see a thick white arrow in the drawing), the low rigidity portion 10a is actively deformed (see a thin arrow in the drawing), so that part of the impact is absorbed by the low rigidity portion 10a. Even in a case where the impact is added in the width direction of the wiring member 1A, the low rigidity portion 10a is actively deformed, so that part of the impact is securely absorbed by the low rigidity portion 10a.

As the low rigidity portion 10a provided in the conductive path 10 (conductive member 11), besides the examples illustrated in FIGS. 2A to 3C, a thin portion compared to the other portions of the conductive member 11, a typical electric wire (wire harness), and a member made of conductive rubber may be employed for example.

In a case where a typical electric wire is employed as the low rigidity portion 10a, the conductive member 11 is connected to the typical electric wire by welding (including ultrasonic welding) for example. In a case where a member made of conductive rubber is employed as the low rigidity portion 10a, the conductive member 11 is connected to the member by a conductive adhesive for example.

In the examples illustrated in FIGS. 2A to 3C, the wiring member 1A is formed as one flat plate conductive path 10, but the wiring member 1A may be formed by stacking a plurality of flat plate conductive paths 10 in the thickness direction.

### Second Embodiment

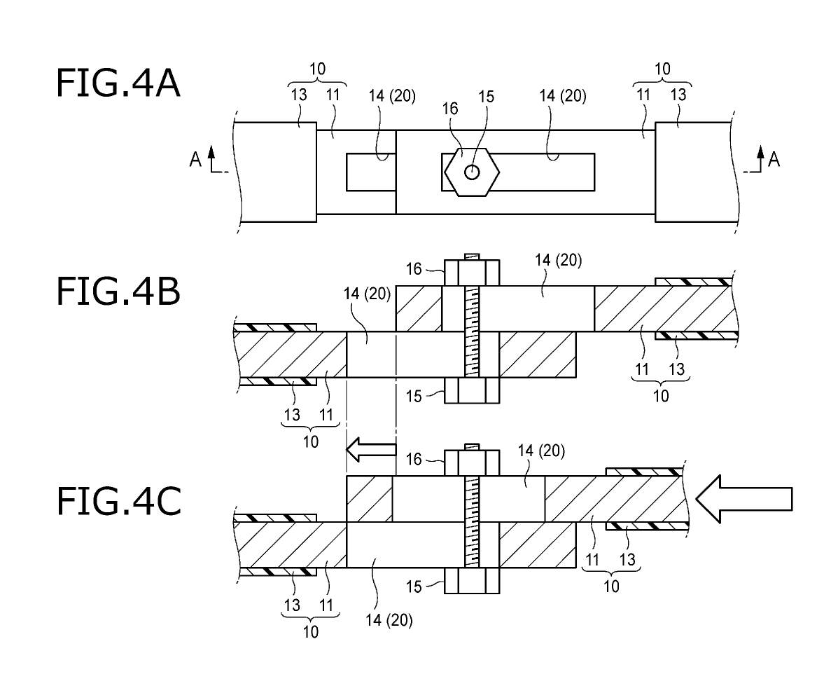

Next, a long wiring member 1A according to a second embodiment of the invention will be described with reference to FIGS. 4A to 4C. As illustrated in FIGS. 4A to 4C, the wiring member 1A has a structure in which a pair of flat plate conductive paths 10 are coupled in a long rod shape. As illustrated in FIGS. 4A and 4B, one end of each of the pair of conductive paths 10 (conductive members 11) forms a coupling portion. In each coupling portion, an insulator 13 is not provided, and the metal conductive member 11 is exposed. The other ends (not illustrated) of the pair of conductive paths 10 (conductive members 11) are connected to the electrical connection box 2 (see FIG. 1).

The coupling portion of each of the pair of conductive members 11 is provided with a through hole 14. The through hole 14 has a shape extending in the longitudinal direction of the conductive member 11. The coupling portions of the pair of conductive members 11 are overlapped, and a bolt 15 passes through the through hole 14. The pair of conductive members 11 (conductive paths 10) are fixed by bolt-fastening the bolt 15 with a nut 16.

As can be seen from FIGS. 4A and 4B, since the through holes 14 extend in the longitudinal direction, the wiring member 1A has a structure that an overlapping portion between the coupling portions in the longitudinal direction is changeable within a predetermined range during bolt-fastening. The structure serves as an impact absorption portion 20.

In other words, as illustrated in FIG. 4C, for example, when an impact is added to one end of the wiring member 1A toward the other end of the wiring member 1A (see a thick white arrow in the drawing), the coupling portions of the pair of conductive members 11 relatively move (slide) in the longitudinal direction to change (increase) the overlapping portion (see a thin arrow in the drawing), so that part of the impact can be absorbed. Even in a case where the impact is added in the width direction (an upward and downward direction in FIG. 4A) of the wiring member 1A is added, the coupling portions of the pair of conductive members 11 relatively slide about the shaft center of the bolt 15, so that part of the impact is securely absorbed. In addition, it is possible to arbitrarily adjust an absorbing degree of impact by adjusting a fastening load of the bolt.

Furthermore, a dimensional variation generated at the time of assembly between the wiring member 1A and the electrical connection box 2 can be absorbed by adjusting the overlapping portion between the coupling portions of the pair of conductive members 11, so that the assembly performance is improved.

In the example illustrated in FIGS. 4A to 4C, the through holes 14 of the pair of conductive members 11 extend in the longitudinal direction, but only the through hole 14 of one of the pair of conductive members 11 may extend in the longitudinal direction. In the example illustrated in FIGS. 4A to 4C, the pair of conductive members 11 have a flat plate shape. But, in a case where the pair of conductive members 11 have a semi-circular shape in cross-sectional view, the similar configuration to that illustrated in FIGS. 4A to 4C can be obtained by crushing only the pair of coupling portions to be flat.

### Third Embodiment

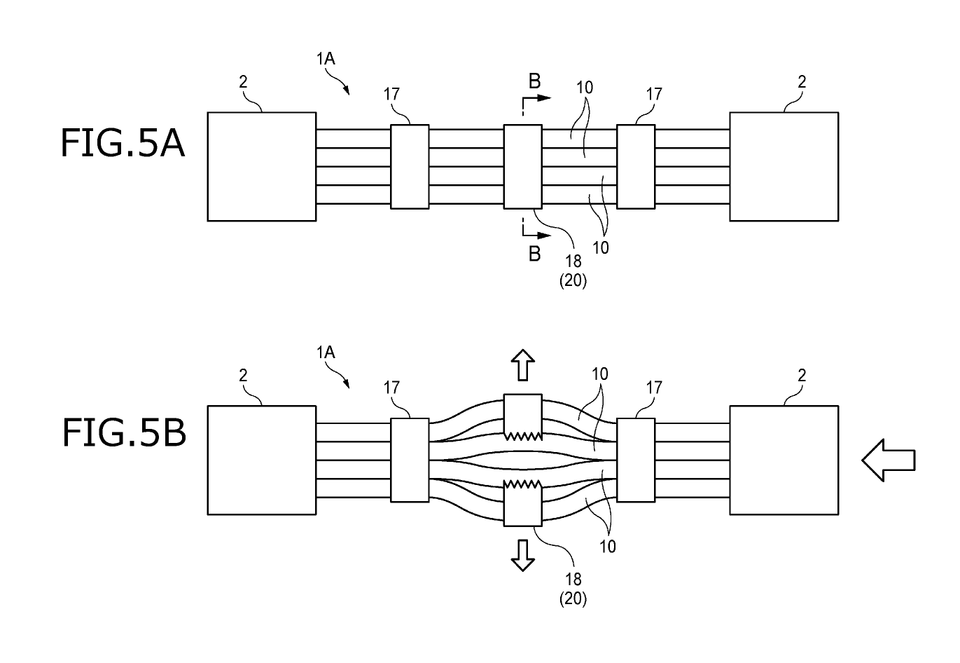

Next, a long wiring member 1A according to a third embodiment of the invention will be described with reference to FIGS. 5A and 5B. As illustrated in FIG. 5A, a plurality (four in this example) of conductive paths 10 are disposed in parallel in the width direction in the wiring member 1A. A cross-sectional shape of each conductive path 10 is, for example, a circular shape. Both ends of each of the plurality of conductive paths 10 are connected to a pair of electrical connection boxes 2.

The wiring member 1A includes a pair of first fixing members 17 which are positioned to be adjacent to the pair of electrical connection boxes 2 between a pair of the electrical connection boxes 2, and collectively fix the plurality of conductive paths 10 to the vehicle body. The first fixing members 17 are members which collectively cover the outer periphery of the plurality of conductive paths 10 arranged in parallel in the width direction in a circular shape. Parts of these members are fixed to the vehicle body. The first fixing members 17 are formed of resin or metal.

The wiring member 1A further includes a second fixing member 18 which is positioned between the pair of first fixing members 17 and collectively fixes the plurality of conductive paths 10 to the vehicle body. Similarly to the first fixing member 17, the second fixing member 18 is also a member which collectively covers the outer periphery of the plurality of conductive paths 10 arranged in the width direction in a circular shape. A part of the member is fixed to the vehicle body. The second fixing member 18 is also formed of resin or metal.

Herein, the second fixing member 18 is different from the pair of first fixing members 17 in, for example, a dimension of the member and a material of the member, so as to easily release the fixing of the conductive path 10 to the vehicle body when receiving an impact. For example, the release of the fixing is achieved when the fixing member is broken away. In this example, the second fixing member 18 serves as an impact absorption portion 20.

In other words, as illustrated in FIG. 5B, for example, when an impact is added to one end of the wiring member 1A toward the other end of the wiring member 1A (see a thick white arrow in the drawing), the pair of first fixing members 17 is not broken away but only the second fixing member 18 is broken away. With this configuration, the conductive paths 10 at the positions of the pair of first fixing members 17 are not allowed to move (be deformed), and thus a large force is not applied on the pair of the electrical connection boxes 2. However, the conductive paths 10 at the position of the second fixing member 18 are allowed to move (be deformed) (see a thin arrow in the drawing), part of the impact can be securely absorbed. Even in a case where an impact is added in the width direction (an upward and downward direction in FIGS. 5A and 5B) of the wiring member 1A, the second fixing member 18 is the first to be broken away, so that the operations and effects similar to the above description can be obtained.

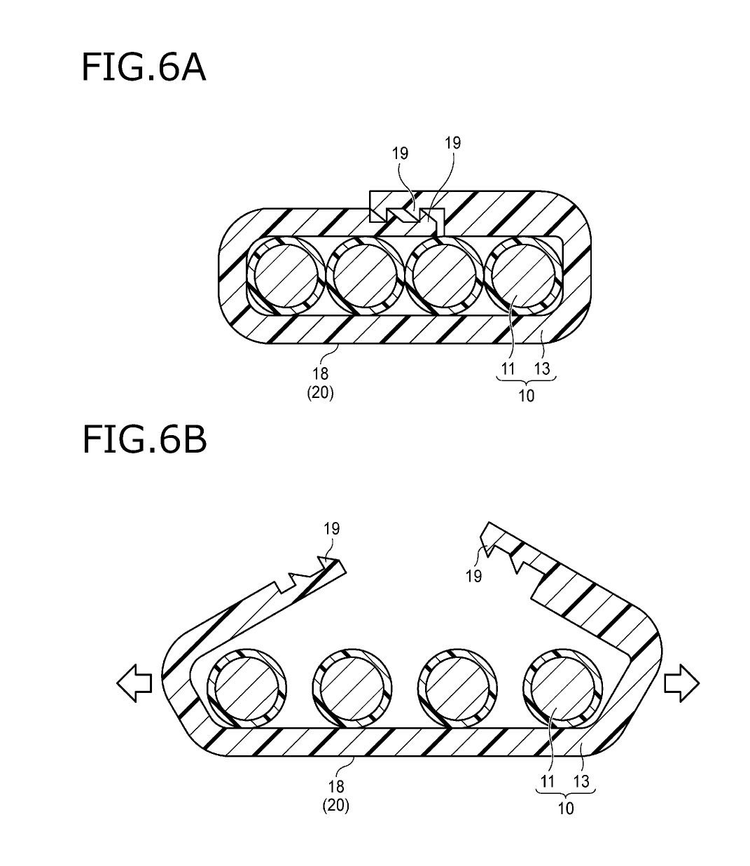

In the example illustrated in FIGS. 5A and 5B, the release of the fixing of the second fixing member 18 is achieved by breaking the second fixing member 18 (see FIG. 5C). With this regard, as illustrated in FIG. 6A, the second fixing member 18 may include a pair of engaging portions 19, and be formed such that the pair of engaging portions 19 are engaged to each other to collectively cover the outer periphery of the plurality of conductive paths 10 in a circular shape so as to fix the plurality of conductive paths 10 to the vehicle body.

In this case, as illustrated in FIG. 6B, the second fixing member 18 releases the engagement of the engaging portions 19 when receiving an impact so as to release the fixing of the plurality of conductive paths 10 to the vehicle body. In the case of the configuration, the second fixing member 18 is reusable unlike a case where the release of the fixing is achieved by breaking.

In the example illustrated in FIGS. 5A and 5B, the wiring member 1A includes the plurality of conductive paths 10, and the plurality of conductive paths 10 are collectively fixed to the vehicle body by the pair of first fixing members 17 and the second fixing member 18. However, the wiring member 1A may include one conductive path 10, and one conductive path 10 may be fixed to the vehicle body by the pair of first fixing members 17 and the second fixing member 18.

In the example illustrated in FIGS. 5A and 5B, the conductive path 10 is fixed the vehicle body only by the pair of first fixing members 17 and one second fixing member 18. However, the conductive path 10 may be fixed to the vehicle body by a plurality of pairs of first fixing members 17 and a plurality of second fixing members 18. In this case, all the plurality of second fixing members 18 are disposed between the pair of first fixing members 17 positioned on the most inner side in the longitudinal direction among the plurality of pairs of first fixing members 17.

Hereinbefore, according to the wiring members 1A of the embodiments of the invention, the impact absorption portion 20 is provided in the conductive member 11, so that part of an impact is absorbed by the impact absorption portion 20 when the impact is added to the conductive member 11. Therefore, a force which is caused by the impact to act on the electrical connection box 2 connected to the wiring member 1A is reduced, and a failure hardly occurs in the electrical connection box 2. Further, the wiring member 1A itself is hardly broken away.

### Others

The invention is not limited to the above embodiments, and various modifications may be employed within the scope of the invention. For example, the invention is not limited to the above-described embodiments, and modifications and improvements may be appropriately made. Besides, the materials, shapes, dimensions, numbers, and layouts of the components of the above-described embodiments may be arbitrary and not limited as long as the invention is achieved.

For example, in the respective embodiments, the wiring member 1A is used as a main-line wiring member (backbone) positioned on the floor panel near the boundary between the floor panel and the dash panel of the vehicle, but the wiring member 1A may be wired in any portion of the vehicle as long as it is wired in the vehicle.

Herein, the features of the embodiments of the vehicular wiring member according to the invention are simply summarized in the following [1] to [6].

[1] A vehicular wiring member (1A) installed in a vehicle, including:

a conductive path (10) that includes a conductive member (11) having an elongated shape,

wherein the conductive path (10) includes an impact absorption portion (20) which has a structure to easily absorb an impact added to the conductive member (11) compared a portion of the conductive path other than the impact absorption portion.

[2] The vehicular wiring member according to [1], wherein the conductive member (11) includes a low rigidity portion (10a) which has a rigidity lower than a portion of the conductive member (11) other than the low rigidity portion (10a); and

wherein the low rigidity portion (10a) serves as the impact absorption portion (20).

[3] The vehicular wiring member according to [2], wherein the conductive member (11) has a flat plate shape; and

wherein the low rigidity portion (10a) is a curved portion which is formed by bending the conductive member (11) a plurality of times in a thickness direction of the conductive member (11) along a longitudinal direction of the conductive member (11).

[4] The vehicular wiring member according to [1], wherein the conductive member (11) is configured by coupling a pair of conductive members (11) to each other in a long rod shape;

wherein the coupling portions of the pair of conductive members (11) has a through hole (14);

wherein the coupling portions are overlapped and a bolt (15) passes through the through holes (14) of the pair of conductive members (11), and the pair of conductive members (11) are fixed by bolt-fastening;

wherein at least one of the through holes (14) extends in the longitudinal direction of the conductive member (11);

wherein the pair of conductive members has a structure in which an overlapping portion in the longitudinal direction of the coupling portions is changeable within a predetermined range during the bolt-fastening; and

wherein the structure serves as the impact absorption portion (20).

[5] The vehicular wiring member according to [1], wherein

both ends of the conductive member (11) are connected to a pair of control devices (electrical connection boxes 2) respectively;

the vehicular wiring member further including:

a pair of first fixing members (17) which are positioned so as to be adjacent to the pair of control devices (electrical connection boxes 2) and between the pair of control devices (electrical connection boxes 2) to fix the conductive member (11) to a vehicle body; and

a second fixing member (18) which is positioned between the pair of first fixing members (17) to fix the conductive member (11) to the vehicle body,

wherein the second fixing member (18) is configured such that fixing of the conductive member (11) to the vehicle body is easily released when receiving an impact compared to the first fixing member (17); and

wherein the second fixing member (18) serves as the impact absorption portion (20).

[6] The vehicular wiring member according to [5], wherein the second fixing member (18) includes a pair of engaging portions (19);

wherein the pair of engaging portions (19) are engaged to each other to annularly cover an outer periphery of the conductive member (11) so as to fix the conductive member (11) to the vehicle body; and

wherein the second fixing member (18) is configured such that engagement of the engaging portions (19) is released when receiving an impact, so as to release the fixing of the conductive member (11) to the vehicle body.

What is claimed is:

1. A vehicular wiring member installed in a vehicle, comprising:
a conductive path that includes a conductive member having an elongated shape,
wherein the conductive path includes an impact absorption portion which has a structure to easily absorb an impact added to the conductive member compared to a portion of the conductive path other than the impact absorption portion.

2. The vehicular wiring member according to claim 1, wherein the conductive member includes a low rigidity portion which has a rigidity lower than a portion of the conductive member other than the low rigidity portion; and
wherein the low rigidity portion serves as the impact absorption portion.

3. The vehicular wiring member according to claim 2, wherein the conductive member has a flat plate shape; and
wherein the low rigidity portion is a curved portion which is formed by bending the conductive member a plurality of times in a thickness direction of the conductive member along a longitudinal direction of the conductive member.

4. The vehicular wiring member according to claim 1, wherein the conductive member is configured by coupling a pair of conductive members to each other in a long rod shape;
wherein each of coupling portions of the pair of conductive members has a through hole;
wherein the coupling portions are overlapped and a bolt passes through the through holes of the pair of conductive members, and the pair of conductive members are fixed by bolt-fastening;
wherein at least one of the through holes extends in the longitudinal direction of the conductive member;
wherein the pair of conductive members has a structure in which an overlapping portion in the longitudinal direction of the coupling portions is changeable within a predetermined range during the bolt-fastening; and
wherein the structure serves as the impact absorption portion.

5. The vehicular wiring member according to claim 1, wherein both ends of the conductive member are connected to a pair of control devices respectively;
the vehicular wiring member further comprising:
a pair of first fixing members which are positioned so as to be adjacent to the pair of control devices and between the pair of control devices to fix the conductive member to a vehicle body; and
a second fixing member which is positioned between the pair of first fixing members to fix the conductive member to the vehicle body,
wherein the second fixing member is configured such that fixing of the conductive member to the vehicle body is easily released when receiving an impact compared to the first fixing member; and
wherein the second fixing member serves as the impact absorption portion.

6. The vehicular wiring member according to claim 5, wherein the second fixing member includes a pair of engaging portions;
wherein the pair of engaging portions are engaged to each other to annularly cover an outer periphery of the conductive member to fix the conductive member to the vehicle body; and
wherein the second fixing member is configured such that engagement of the engaging portions is released when receiving an impact, so as to release the fixing of the conductive member to the vehicle body.
